(19) United States
(12) Patent Application Publication
(10) Pub. No.: US 2005/0262536 A1
(43) Pub. Date: Nov. 24, 2005

(54) Video data reproducing apparatus, video data reproducing method, video data transfer system and data transfer method for video data transfer system

(76) Inventors: Kaoru Urata, Kanagawa (JP); Hideki Arai, Kanagawa (JP); Masayuki Wada, Kanagawa (JP); Yoshiaki Tanaka, Kanagawa (JP)

Correspondence Address: FROMMER LAWRENCE & HAUG LLP, 745 FIFTH AVENUE, NEW YORK, NY, 10151, US

(21) Appl. No.: 11/130,620

(22) Filed: May 17, 2005

(30) Foreign Application Priority Data
May 18, 2004 (JP) P2004-148017

(51) Int. Cl. H04N 7/00; H04N 7/18

(52) U.S. Cl. 725/80; 386/46; 725/74

(57) ABSTRACT

A video data reproducing apparatus and a video data transfer system are able to reproduce video data of a range designated by file information from a VTR (video tape recorder) based on the fact that the file information for designating video data of a constant range of video data with high resolution such as a non-compressed HDTV (high-definition television) signal recorded on the VTR and a transfer command for requesting transfer of video data of the range designated by this file information are received from a computer through a LAN (local area network) and they are able to transfer reproduced video data through a high-speed network to the computer.

### CROSS REFERENCES TO RELATED APPLICATIONS

The present invention contains subject matter related to Japanese Patent Application JP 2004-148017 filed in the Japanese Patent Office on May 18, 2004, the entire contents of which being incorporated herein by reference.

### BACKGROUND OF THE INVENTION

1. Field of the Invention

The present invention generally relates to a video data transfer system for transferring video data to a computer from a video data reproducing apparatus such as a VTR (video tape recorder), and particularly to a system capable of transferring video data with high resolution to a video data reproducing apparatus at high speed.

2. Description of the Related Art

In a post-production process (finish process up to the completion of a video product after editing) of a manufacturing process of a video product such as a television program and a cinema product, it is customary to use a nonlinear editing system composed of suitable devices such as a computer and a recording apparatus which can be randomly accessed to edit video data. In such nonlinear editing system, video data is managed at the unit of file by a file system of an OS (operating system) of the computer. Therefore, video data that has been recorded on a video tape at the shooting spot should be added to the nonlinear editing system as a file.

So far the following method (a) or (b) has been mainly used as a method for adding video data to the nonlinear editing system as a file.

(a) A PCI (peripheral component interconnect) card (for example, an SDI (selective dissemination of information) card) to capture video data is attached to a computer within the nonlinear editing system. Video data reproduced by a VTR in a real-time fashion is transferred through this PCI card to the computer and this video data is added to the computer as a file.

(b) Video data reproduced by the VTR in a real-time fashion is transferred to a hard disk recorder and it is thereby added to this hard disk recorder as a file. Then, this file is transferred from the hard disk recorder to the nonlinear editing system.

However, according to the above-described method (a), since the operation environment of the PCI card depends on the hardware (CPU (central processing unit), memory, etc.) of the computer and the OS of the computer, when the computer for use in the nonlinear editing system is changed to a new type or when version up of the OS is made, it is frequently observed that the PCI card also should be changed.

Also, according to the above-described method (b), the hard disk recorder should be provided additionally in the nonlinear editing system and hence the nonlinear editing system should become large in size.

On the other hand, in order to remove the shortcomings encountered with the above-described methods (a) and (b), there has been proposed a method in which a VTR itself includes a LAN (local area network) interface, the VTR and the computer within the nonlinear editing system are directly connected by the LAN to transfer video data of a constant range from the VTR to the computer as a file (see Cited Patent Reference 1, for example).

[Cited Patent Reference 1]: Official Gazette of Japanese laid-open patent application No. 2003-87699 (paragraph Nos. [0021] to [0029] and FIGS. 1 and 2).

If video data is transferred from the VTR itself to the computer through the LAN as the file, then without depending on the hardware of the computer and the OS of the computer like the above-described method (a) and without causing the nonlinear editing system to become large in size like the above-described method (b), the video data can be added to the nonlinear editing system as the file.

However, when the file of video data is transferred to the computer through the LAN, processing of an IP (Internet protocol) imposes a large load upon the CPU of the computer. For this reason, even when a LAN with a high transfer rate, such as a giga-Ethernet (“Ethernet” is a registered trademark), for example, is used, effective throughput is approximately 300 Mbps at the best.

When video data recorded on the video cassette tape is an SDTV (standard-definition television) signal or a compressed HDTV (high-definition television) signal, since a data rate is approximately several los of Mbps, it is sufficient that throughput may be about 300 Mbps.

However, when video data recorded on the video cassette tape is a non-compressed HDTV signal, a data rate becomes approximately 2 Gbps at the maximum. Therefore, at the throughput of approximately 300 Mbps, it takes more than several minutes to transfer video data of a data amount corresponding to one-minute scene to the nonlinear editing system as a file. Such a long transfer time is very inconvenient from an editing standpoint.

Further, although it is expected that a signal with high resolution higher than that of the HDTV signal will be put into practice in the future, a data rate of such high-resolution signal is increased more. Accordingly, it is expected that a problem of a long transfer time will become more serious.

### SUMMARY OF THE INVENTION

In view of the aforesaid aspect, the present invention intends to enable video data with high resolution such as a non-compressed HDTV signal to be transferred from a VTR and other video data reproducing apparatus to a computer at high speed in a nonlinear editing system and the like so that such video data can be added to the computer as a file.

According to an aspect of the present invention, there is provided a video data reproducing apparatus for reproducing video data from a recording medium. This video data reproducing apparatus comprises a connection device for a LAN, a connection device for a high-speed network of any transfer system of serial transfer and parallel transfer and a processing device for reproducing video data of a range designated by file information from the recording medium based on the fact that the file information for designating video data of a constant range of video data recorded on the recording medium as a file and a transfer command for requesting transfer of video data of the range designated by the file information are received through the LAN and transferring reproduced video data through the high-speed network.

Since this video data reproducing apparatus includes not only the LAN connection device but also the high-speed network connection device of any transfer system of the serial transfer and the parallel transfer, when it receives the file information for designating the video data of the constant range as the file and the transfer command for requesting transfer of the video data through the LAN, such video data is transferred as a file through the high-speed network.

Accordingly, when this video data reproducing apparatus and the computer are connected through both of the LAN and the high-speed network and the file information for designating the video data of the constant range as the file (that is, file information necessary for adding the file) and the transfer command are transmitted from this computer through the LAN to this video data reproducing apparatus, the video data of the designated range is transferred from this video data reproducing apparatus to the computer through the high-speed network as the file.

As described above, since the two paths are properly chosen in use in such a manner as to transmit the file information necessary for adding the file and the transfer command not through the high-speed network but through the LAN (that is, not a protocol inherent in the high-speed network but a general protocol such as an http protocol) and also in such a manner as to transmit video data of a large data amount through the high-speed network which can transmit data at high speed, a load imposed on the CPU of the computer can be lightened and video data with high resolution can be transferred from the video data reproducing apparatus to the computer at high speed and thereby such video data can be added to the computer as the file.

By way of example, it is suitable that this video data reproducing apparatus may further include a processing device for reproducing video data from the recording medium based on the fact that a reproducing command of video data is received through the LAN and wherein the processing device may decode reproduced video data to provide proxy video data and it may transfer the proxy video data through any one of the LAN and the high-speed network.

Therefore, when this video reproducing apparatus and the computer are connected by both of the LAN and the high-speed network, if the reproducing command of video data is transmitted from this computer through the LAN to this video data reproducing apparatus, then the proxy video data can be transferred from this video data reproducing apparatus through the LAN or the high-speed network to this computer.

Accordingly, the operator can display the proxy video data on the monitor of the computer and hence it becomes possible for the operator to decide the range of the video data to be added to the computer as the file before the file information necessary for adding the video data as the file (file information for designating the video data of the constant range as the file) is transmitted to the video data reproducing apparatus.

Also, by way of example, it is suitable that this video data reproducing apparatus may use a fiber channel as the high-speed network. As a result, it becomes possible to transfer video data with high resolution to the computer at high speed via a SCSI (small computer system interface) protocol which is a relatively simple protocol.

Also, by way of example, it is suitable that this video data reproducing apparatus may reproduce video data from a tape-like recording medium. As a result, it becomes possible to transfer video data with high resolution recorded on the tape-like recording medium to the computer at high speed.

According to other aspect of the present invention, there is provided a video data transfer system comprising a video data reproducing apparatus including a connection device for a LAN and a connection device for a high-speed network of any transfer system of serial transfer and parallel transfer and reproducing video data from a recording medium and a computer including a connection device for a LAN and a connection device for a high-speed network, wherein the video data reproducing apparatus reproduces video data of a range designated by file information from the recording medium based on the fact that the file information for designating video data of a constant range of video data recorded on the recording medium as a file and a transfer command for requesting transfer of video data of a range designated by the file information are received through the LAN and it transfers reproduced video data to the computer through the high-speed network and the computer adds video data received through the high-speed network as a file.

In this video data transfer system, the video data reproducing apparatus includes not only the LAN connection device but also the high-speed network connection device of any transfer system of the serial transfer and the parallel transfer. Further, the computer also includes the LAN connection device and the high-speed network connection device as well, and this video data reproducing apparatus and the computer are connected by both of the LAN and this high-speed network.

Then, this video data reproducing apparatus reproduces the video data of the range designated by the file information from the recording medium based on the fact that the file information for designating the video data of the constant range of the video data recorded on the recording medium as the file and the transfer command for requesting transfer of the video data of the range designated by this file information are received through the LAN (from this computer or other node) and it transfers the reproduced video data through the high-speed network to the computer. The computer adds the thus transferred video data thereto as the file.

As described above, since the two paths are properly chosen in use in such a manner as to transmit the file information necessary for adding the file and the transfer command through the LAN (that is, a general protocol such as an http protocol) and also in such a manner as to transmit video data of a large data amount through the high-speed network, a load imposed on the CPU of the computer can be lightened and video data with high resolution can be transferred from the video data reproducing apparatus to the computer at high speed and thereby such video data can be added to the computer as the file.

According to a further aspect of the present invention, there is provided a video data transfer system comprising a video data reproducing apparatus including a connection device for a LAN and a connection device for a high-speed network of any transfer system of serial transfer and parallel transfer, a computer including a connection device for a LAN and a connection device for a high-speed network and a recording apparatus connected to the computer through the high-speed network and which can be randomly accessed, wherein the video data reproducing apparatus reproduces video data of a range designated by file information from the recording medium based on the fact that file information for designating video data of a constant range of video data recorded on the recording medium as a file and a transfer command for requesting transfer of video data of a range designated by the file information are received through the LAN and it transfers reproduced video data to the computer through the high-speed network and the computer adds video data received through the high-speed network as a file and it transfers the video data to the recording apparatus through the high-speed network so that the video data is stored in the recording apparatus.

In this video data transfer system, the video data reproducing apparatus includes not only the LAN connection device but also the connection device to the high-speed network of any transfer system of the serial transfer and the parallel transfer. Further, the computer also includes the LAN connection device and the high-speed network connection device, and this video data reproducing apparatus and the computer are connected by both of the LAN and the high-speed network. Furthermore, this computer and the recording apparatus, which can be randomly accessed, are connected by this high-speed network.

Then, this video data reproducing apparatus reproduces video data of a range designated by file information from the recording medium based on the fact that file information for designating the video data of the constant range of the video data recorded on the recording medium as the file and the transfer command for requesting transfer of the video data of the range designated by this file information are received and it transfers the reproduced video data through the high-speed network to the computer. This computer adds the transferred video data thereto as the file and it transfers the reproduced video data through the high-speed network to this recording apparatus so that the thus transferred video data may be stored in this recording apparatus.

As described above, since the two paths are properly chosen in use in such a manner as to transmit the file information necessary for adding the file and the transfer command through the LAN (that is, a general protocol such as an http protocol) and also in such a manner as to transmit video data of a large data amount through the high-speed network, a load imposed on the CPU of the computer can be lightened and video data with high resolution can be transferred from the video data reproducing apparatus to the computer at high speed and thereby such video data can be added to the computer as the file.

Also, since the added file is transferred through the high-speed network to the recording apparatus which can be randomly accessed and thereby it is stored in the recording apparatus, in a SAN (storage area network), for example, it becomes possible for a plurality of servers to share this file.

According to a further aspect of the present invention, there is provided a video data reproducing method for reproducing video data from a recording medium and transferring reproduced video data. This video data reproducing method comprises the steps of a receiving step for receiving file information for designating video data of a constant range of video data recorded on the recording medium and a transfer command for requesting transfer of video data of the range designated by the file information through the LAN, a reproducing step for reproducing the video data of the range designated by the file information from the recording medium and a video data transfer step for transferring the reproduced video data through a high-speed network of any transfer system of serial transfer and parallel transfer.

In accordance with yet a further aspect of the present invention, there is provided a data transfer method for a video data transfer system comprising a video data reproducing apparatus including a connection device for a LAN and a connection device for a high-speed network of any transfer system of serial transfer and parallel transfer and which reproduces video data from a recording medium and a computer including a connection device for a LAN and a connection device for a high-speed network. The video data reproducing apparatus includes the steps of a reception step for receiving file information for designating video data of a constant range of video data recorded on the recording medium and a transfer command for requesting transfer of video data of the range designated by the file information through the LAN and a reproducing step for reproducing the video data of the range designated by the file information from the recording medium, a transfer step for transferring the reproduced video data through the high-speed network to the computer and the computer includes an adding step for adding the video data received through the high-speed network as a file.

In accordance with yet a further aspect of the present invention, there is provided a data transfer method for a video data transfer system which comprises a video data reproducing apparatus including a connection device for a LAN and a connection device for a high-speed network of any transfer system of serial transfer and parallel transfer and reproducing video data from a recording medium, a computer including a connection device for a LAN and a connection device for a high-speed network and a recording apparatus connected to the computer by the high-speed network and which can be randomly accessed. The video data reproducing apparatus includes a receiving step for receiving file information for designating video data of a constant range of video data recorded on the recording medium as a file and a transfer command for requesting transfer of video data of the range designated by the file information through the local area network, a reproducing step for reproducing the video data of the range designated by the file information from the recording medium and a transfer step for transferring the reproduced video data through the high-speed network to the computer and the computer includes the adding step for adding video data received through the high-speed network as a file and the recording apparatus, which can be randomly accessed, includes a storage step for storing video data file transferred through the high-speed network.

According to the present invention, when the video data is transferred from the video data reproducing apparatus, which reproduces the video data from the recording medium, to the computer and thereby the transferred video data is added to the computer as the file, since the two paths are properly chosen in use in such a manner as to transmit the file information necessary for adding the file and the transfer command through the LAN (that is, the general protocol such as the http protocol) and in such as manner as to transmit the video data of the large data amount through the high-speed network of the serial transfer system or the parallel transfer system, the load imposed on the CPU of the computer can be lightened. Also, the video data with high resolution can be transferred from the video data reproducing apparatus to the computer at high speed and this video data can be added to the computer as the file.

Also, since the added file is transferred through the high-speed network to the recording apparatus which can be randomly accessed and thereby stored in this recording apparatus, in the SAN (storage area network), for example, a plurality of servers can share this file.

Also, the operator can display the proxy video data on the monitor of the computer and hence it is possible for the operator to decide the range of the video data to be added to the computer as the file before the file information necessary for adding the file is transmitted to the video data reproducing apparatus.

Further, the video data with the high resolution can be transferred to the computer at high speed by the SCSI protocol which is the relatively simple protocol.

The video data with the high resolution can be transferred from the tape-like recording medium to the computer at high speed.

### BRIEF DESCRIPTION OF THE DRAWINGS

FIG. 1 is a schematic diagram showing the state in which a VTR to which the present invention is applied is connected to a computer located within a nonlinear editing system;

FIG. 2 is a block diagram showing a circuit arrangement of the VTR shown in FIG. 1;

FIG. 3 is a flowchart to which reference will be made in explaining processing executed by the system CPU shown in FIG. 2 in order to make suitable processing such as transfer of video data;

FIG. 4 is a pictorial representation showing an example of a GUI (graphical user interface) picture displayed on the monitor of the computer shown in FIG. 1;

FIG. 5 is a flowchart to which reference will be made in explaining processing executed by the CPU within the computer shown in FIG. 1 based on operations on the GUI picture;

FIG. 6 is a schematic diagram showing an example of a picture displayed on the monitor of the computer shown in FIG. 1 by the processing shown in FIG. 5; and

FIG. 7 is a schematic diagram showing an example in which the present invention is applied to a more expanded nonlinear editing system.

### DESCRIPTION OF THE PREFERRED EMBODIMENTS

Examples in which the present invention is applied to a VTR (video tape recorder) and a nonlinear editing system will be described below with reference to the drawings.

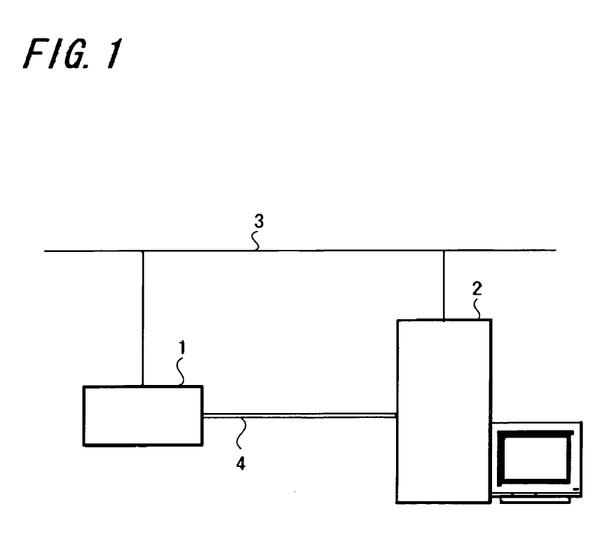

FIG. 1 of the accompanying drawings is a schematic diagram showing the state in which a VTR to which the present invention is applied is connected to a computer located within a nonlinear editing system.

As shown in FIG. 1, a VTR 1 includes an Ethernet interface and a fiber channel interface. A computer (workstation or personal computer) 2 located within a nonlinear editing system also includes an Ethernet interface and a fiber channel interface as well.

The VTR 1 and the computer 2 are connected together via both an Ethernet (for example, giga-Ethernet) 3 and a fiber channel 4. Alternatively, the VTR 1 and the computer 2 may house therein an Ethernet interface and a fiber channel interface or they may have those interfaces mounted thereon in the form of boards.

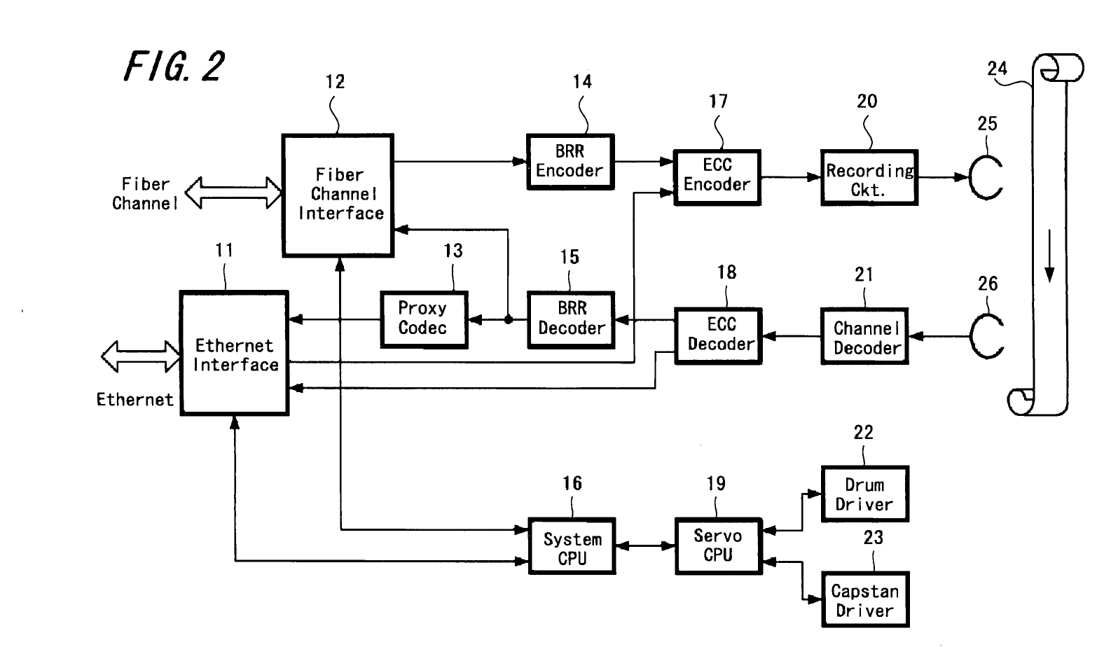

FIG. 2 is a block diagram showing a circuit arrangement of the VTR 1. As shown in FIG. 2, the VTR 1 includes an Ethernet interface 11 and a fiber channel interface 12. When video data is received by the fiber channel 12, the received video data is compressed by a BRR (bit rate reduction) encoder 14, it is added with a parity code by an ECC (error correction code) encoder 17 and it is processed by suitable data processing such as modulation in a recording circuit 20, whereafter the processed data is recorded on a magnetic tape 24 by a recording head 25.

Also, when audio data or meta-data is received by the Ethernet interface 11, the audio data or the meta-data is added with a parity code by the ECC encoder 17 and it is processed by suitable data processing such as modulation in the recording circuit 20, whereafter the processed data is recorded on the magnetic tape 24 by the recording head 25.

A signal reproduced from the magnetic tape 24 by a reproducing head 26 with a plurality of channels is supplied to a channel decoder 21, in which it is decoded in channel and error-corrected by an ECC decoder 18. The video data outputted from the ECC decoder 18 is expanded by the BRR decoder 15 and supplied to the fiber channel interface 12. At the same time, this video data is compressed by the proxy codec 13 as proxy video data (video data with lower resolution) and supplied to the Ethernet interface 11.

The audio data and the meta-data outputted from the ECC decoder 18 are transmitted to the Ethernet interface 11.

Information and commands other than the audio data and the meta-data received at the Ethernet interface 11 are transmitted to a system CPU (central processing unit) 16 that controls the whole of the VTR 1. Based on the information and the commands, the system CPU 16 controls a drum driver 22 and a capstan driver 23 through a servo CPU 19 and it also sets signal processing in each encoder and decoder.

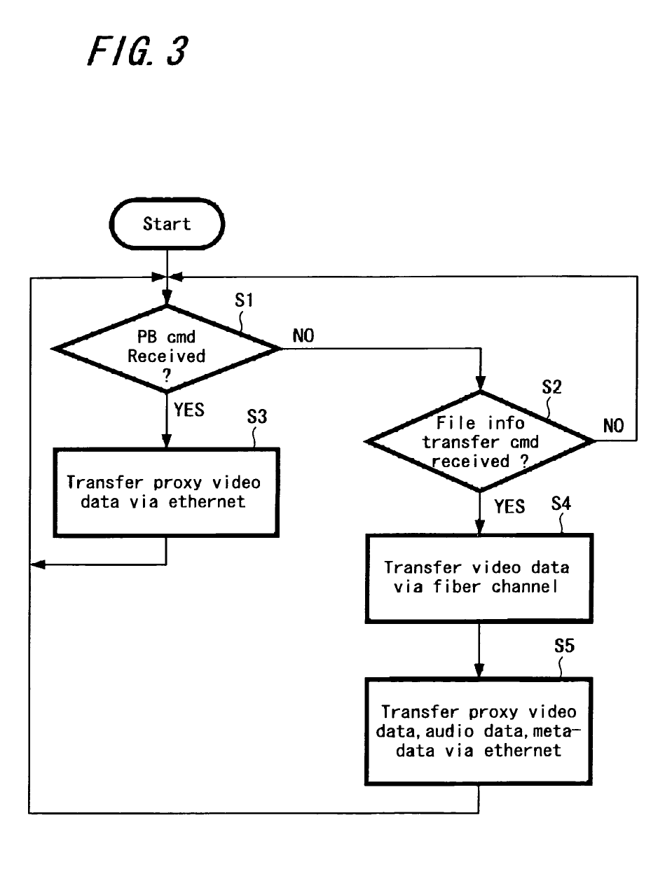

FIG. 3 is a flowchart to which reference will be made in explaining processing executed by the system CPU 16 to execute suitable processing such as transfer of video data. In this processing, a decision step (decision step S1) for determining whether or not a reproducing command of video data such as a shuttle transfer command is received and a decision step (decision step S2) for determining whether or not file information for designating video data of a constant range of the video data recorded on the magnetic tape 24 as file and a transfer command for requesting transfer of video data in the range designated by the file information are received are repeated until a YES is outputted at any one of the steps S1 and S2.

Referring to the start of operations, and if a reproducing command is received as represented by a YES at the decision step S1, then control goes to a step S3, whereat the system CPU 16 controls the drum driver 22 and the capstan driver 23 based upon the reproducing command to enable the reproducing head 26 to reproduce video data and in which proxy video data obtained by signal processing executed at the channel decoder 21, the ECC decoder 18, the BRR decoder 15 and the proxy codec 13 is transferred from the Ethernet interface 11 to the transmission source node of the reproducing command. Then, control goes back to the decision step S1.

If the file information and the transfer command are received as represented by a YES at the decision step S2, then control goes to a step S4, whereat the system CPU 16 controls the drum driver 22 and the capstan driver 23 to enable the reproducing head 26 to reproduce video data (clip) of a designated range and in which video data obtained by signal processing executed at the channel decoder 21, the ECC decoder 18 and the BRR decoder 15 is transferred from the fiber channel interface 12 to the fiber channel. Then, control goes to a step S5, whereat proxy video data obtained by signal processing executed at the channel decoder 21, the ECC decoder 18, the BRR decoder 15 and the proxy codec 13 and audio data and meta-data obtained by signal processing executed at the channel decoder 21 and the ECC decoder 18 are transferred from the Ethernet interface 11 to the Ethernet. Then, control goes back to the decision step S1.

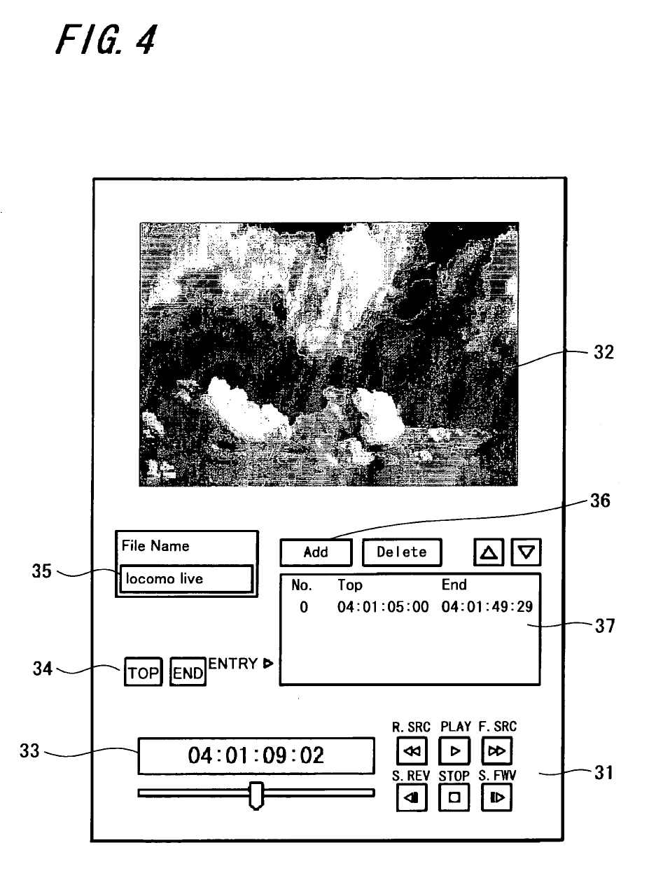

A GUI (graphical user interface) picture, which is used to add video data within the VTR 1 to the nonlinear editing system as a file is displayed on the monitor of the computer 2 shown in FIG. 1. FIG. 4 is a pictorial representation showing an example of this GUI picture. As shown in FIG. 4, on this GUI picture, there are displayed a VTR control button 31 for enabling the VTR 1 to execute shuttle playback, one-time normal speed playback, fast-forward playback, rewind playback and stop of playback, an image display portion 32 on which video data, which is being reproduced, is displayed, a time code display portion 33 for displaying time codes of video data being reproduced, a TOP/END selection button 34 for selecting a range (starting portion and ending end portion) of video data to be added as a file, a file name input portion 35 for inputting a file name of a file to be added, an add button 36 for deciding operation contents of the TOP/END selection button 34 and inputted contents of the file name input portion 35 (that is, to add a file), a file range display portion 37 for displaying a range of an added file (time codes of the starting portion and the ending end portion) and the like.

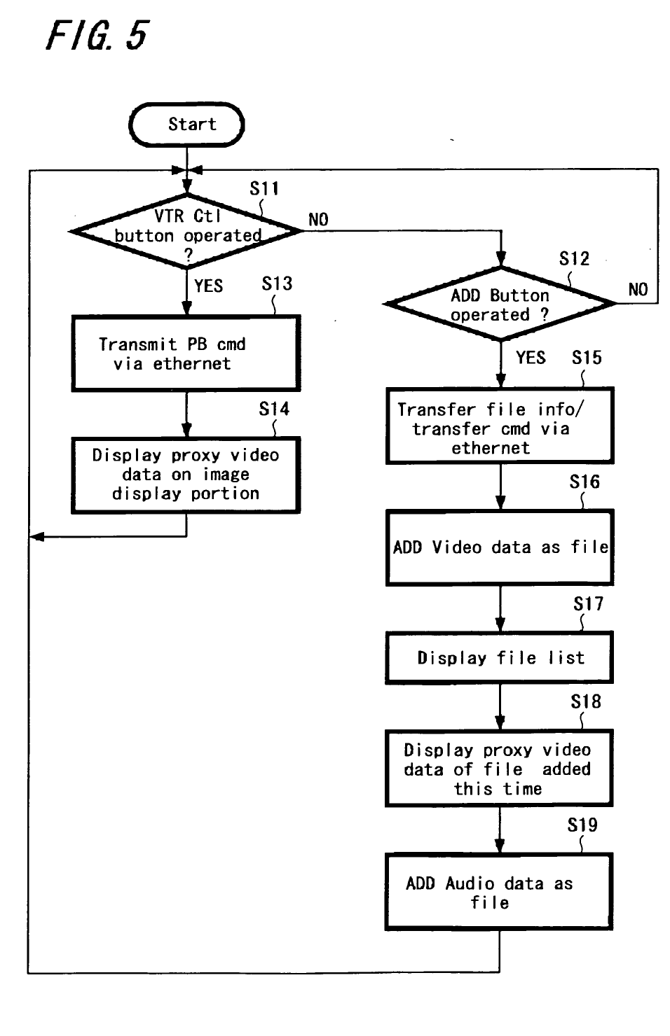

FIG. 5 is a flowchart showing processing that is executed by the CPU within the computer 2 based on operations on this GUI picture. In this processing, a decision step (decision step S11) for determining whether or not the VTR control button 31 (FIG. 4) for reproducing video data is operated and a decision step (decision step S12) for determining whether or not the add button 36 (FIG. 4) is operated are repeated until a YES is outputted at any one of the decision steps S11 and S12.

Referring to FIG. 5 in detail, and following the start of operations, if the VTR control button 31 is operated as represented by a YES at the decision step S11, then control goes to a step S13, whereat a playback command corresponding to the operation contents of the VTR control button 31 (a shuttle playback command when a shuttle playback button, for example, is operated) is transmitted from the computer 2 through the Ethernet 3 (FIG. 1) to the VTR 1 (FIG. 1).

Subsequently, if the VTR 1 receives proxy video data through the Ethernet 3, then control goes to a step S14, whereat the proxy video data is displayed on the image display portion 32 (FIG. 4) of this GUI picture. Then, control goes back to the decision step S11.

If the add button 36 is operated as represented by a YES at the decision step S12, then control goes to a step S15, whereat file information for designating video data of the range selected by the TOP/END selection button 34 immediately before the add button 36 is operated and a transfer command for requesting transfer of video data in the range indicated by this file information are transmitted from the computer 2 through the Ethernet 3 to the VTR 1.

Subsequently, if the VTR 1 receives video data through the fiber channel 4, then control goes to a step S16, whereat this video data is added (stored in a hard disk within the computer 2) as a file. Then, control goes to a step S17, whereat the picture on the monitor of the computer 2 is switched and a list of added files is displayed on the monitor of the computer 2.

Also, if the VTR 1 receives proxy video data (that is, proxy video data of the file added this time) through the Ethernet 3, then control goes to a step S18, whereat the above proxy video data is displayed on the monitor of the computer 2. Further, if the VTR 1 receives audio data through the Ethernet 3, then control goes to a step S19, whereat such audio data is added to the computer 2 as a file. Then, control goes back to the decision step S11.

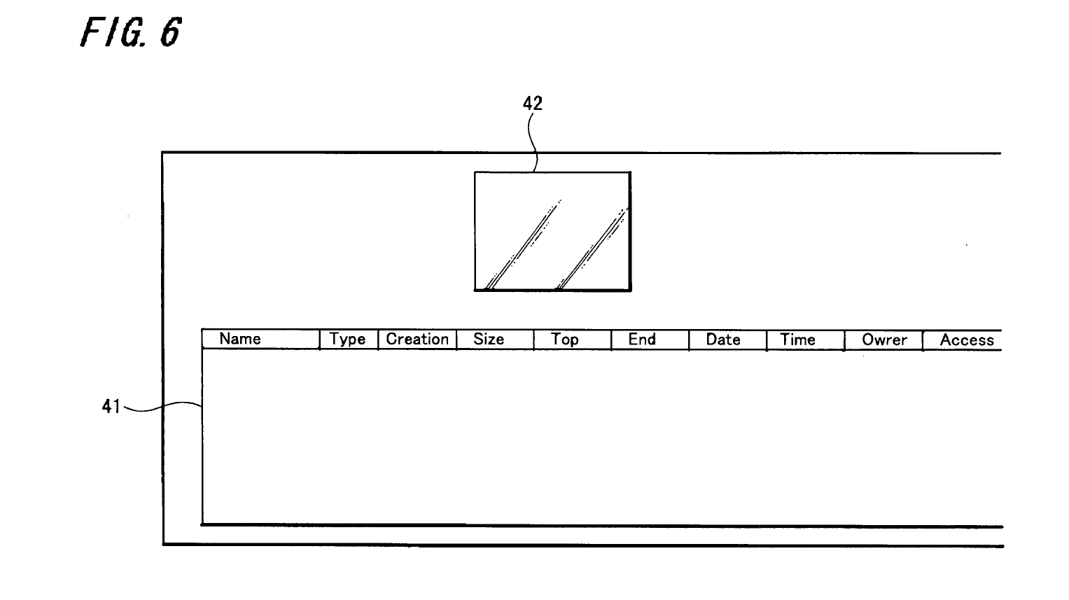

FIG. 6 is a schematic diagram showing an example of a picture displayed on the monitor of the computer 2 by the processing of the steps S17 and S18 shown in FIG. 5. As shown in FIG. 6, this picture is composed of a file list display portion 42 in which a file name of each added file, a file size, time codes of a starting portion and an ending end portion and time and date in which a file is added are displayed and an image display portion 42 in which proxy video data of the file added this time is displayed.

The manner in which video data within the VTR 1 is added to the computer 2 shown in FIG. 1 as a file will be described below. If an operator who operates the computer 2 operates the shuttle playback button, for example, of the VTR control button 31 on the GUI picture shown in FIG. 4, then the shuttle playback command is transmitted from the computer 2 through the Ethernet 3 to the VTR 1 (steps S11 and S13 shown in FIG. 5).

The VTR 1 reproduces video data in the shuttle playback mode based on this shuttle playback command, and proxy video data of which resolution was lowered is transferred through the Ethernet 3 to the computer 2 (steps S1 and S3 shown in FIG. 3).

In the computer 2, the thus transferred proxy video data is displayed on the image display portion 32 of the GUI picture shown in FIG. 4 (step S14 shown in FIG. 5). Then, while watching the shuttle images on this image display portion 32, the operator selects the range of the video data to be added as a file with the TOP/END selection button 34 and the operator enters a file name of the file to be added into the file name input portion 35. Thereafter, when the operator operates the add button 36, file information for designating the video data of the range selected by the TOP/END selection button 34 as the file and a transfer command for requesting transfer of the video data of the range shown by this file information are transferred from the computer 2 through the Ethernet 3 to the VTR 1 (steps S12 and S15 shown in FIG. 5).

The VTR 1 reproduces the video data (clip) of the designated range based on the file information and the transfer command. Also, the video data is transferred through the fiber channel 4 to the computer 2 and the proxy video data with resolution lower than that of the video data, audio data and meta-data are transferred through the Ethernet 3 to the computer 2 (steps S2, S4 and S5 shown in FIG. 3).

In the computer 2, the thus transferred video data is added thereto as the file and a list of added files is displayed on the monitor thereof (file list display portion 41 shown in FIG. 6). At the same time, the thus transferred proxy video data (proxy video data of the file added this time) is displayed on the monitor thereof (image display portion 42 shown in FIG. 6) (steps S16 to S18 shown in FIG. 5).

As described above, since the two paths are properly chosen in use in such a manner as to transmit the file information necessary for adding the file and the transfer command, the proxy video data, the audio data and the meta-data not through the fiber channel 4 but through the Ethernet 3 (that is, not through the protocol inherent in the fiber channel 4 but through the general protocol such as an http protocol and an FTP protocol) and in such a manner as to transmit video data of a large data amount through the fiber channel 4 through which data can be transferred at high speed, a load imposed upon the CPU of the computer can be lightened, and video data with high resolution (for example, non-compressed HDTV signal and signal with resolution higher than that of the HDTV signal) recorded on the magnetic tape 24 (FIG. 2) can be transferred from the VTR 1 to the computer 2 at high speed and thereby can be added to the computer 2 as the file.

Also, the operator can display the proxy video data on the monitor of the computer 2 and the operator can decide the range of the video data that is added to the computer as the file before the file information necessary for adding the file (file information for designating the video data of the constant range as the file) is transmitted to the VTR 1.

Further, since the fiber channel 4 is used as the high-speed network through which this video data is transferred, video data with high resolution can be transferred to the computer 2 at high speed by a SCSI protocol which is a relatively simple protocol.

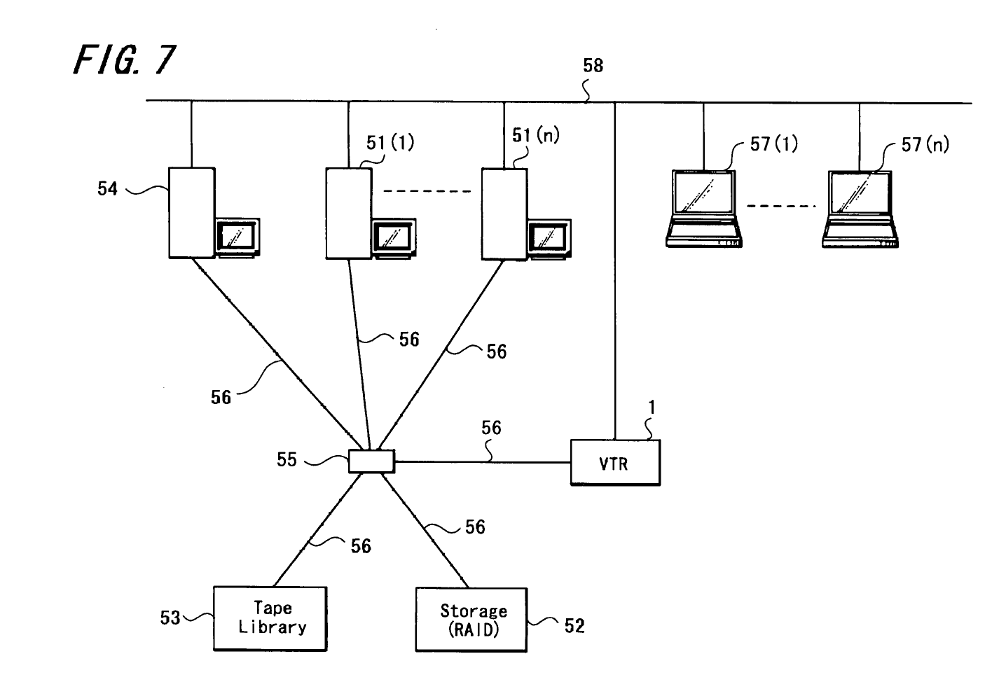

FIG. 7 is a schematic block diagram showing an example in which the present invention is applied to a more expanded nonlinear editing system.

As shown in FIG. 7, in this nonlinear editing system, a SAN (storage area network) is constructed by connecting the VTR 1, a plurality of workstations (servers) 51 (1) to 51 (n), each of which includes an Ethernet interface and a fiber channel interface, a large storage-capacity storage 52 having a RAID (redundant array of inexpensive disks) arrangement and a meta-data server 54 by a switch (fabric switch) 55 with a fiber channel 56.

Also, the VTR 1, the respective workstations 51 (1) to 51 (n) and a plurality of personal computers (end user clients) 57 (1) to 57 (m) are connected together by an Ethernet (for example, giga-Ethernet) 58.

In this nonlinear editing system, the function of the computer 2 shown in FIG. 1 is shared by the workstation 51 (1) and the personal computer 57 (1). More specifically, the personal computer 57 (1) includes the display function of the GUI picture shown in FIG. 4 and the file information and transfer command transmission function based on the operation on this GUI picture and the workstation 51 (1) includes the function to add video data as a file. Also, the workstation 51 (1) transfers the added file through the fiber channel 56 and the switch 55 to the storage 52 and thereby it is filed in the storage 52.

In accordance with the processing executed by the computer 2 as has been described so far with reference to FIG. 5, the steps S11 to S15 and the steps S17, 18 are executed by the personal computer 57 (1), and the steps S16, S19 are executed by the workstation 51 (1).

The personal computers 57 (2) to 57 (m) have function to edit files stored in the storage 52 by using the workstations 51 (2) to 51 (n) as the servers. The meta-data server 54 controls access of each of the workstations 51 (1) to 51 (n) to the storage 52 and the tape library 53 based on a CXFS (“CXFS” is a registered trademark), which is a shared file system, by using a token.

In this nonlinear editing system, video data within the VTR 1 will be transferred to and added to the workstation 51 (1) as a file as follows.

When the operator who operates the personal computer 57 (1) operates the shuttle playback button, for example, of the VTR control button 31, a shuttle playback command is transmitted from the personal computer 57 (1) through the Ethernet 58 to the VTR 1.

The VTR 1 reproduces video data based on this shuttle playback command in a shuttle playback fashion and proxy video data with lowered resolution is transferred from the VTR 1 through the Ethernet 58 to the personal computer 57 (1) (steps S1 and S3 shown in FIG. 3).

In the personal computer 57 (1), the thus transferred proxy video data is displayed on the image display portion 32 of the GUI picture shown in FIG. 4. Then, while watching shuttle images on this image display portion 32, when the operator operates the add button 36 after the operator has selected the range of video data to be added as a file with the TOP/END selection button 34 and the operator has entered a file name of a file to be added into the file name input portion 35, file information for designating the video data of the range selected by the TOP/END selection button 34 and a transfer command for requesting transfer of the video data of the range indicated by this file information to the workstation 51 (1) are transmitted from the personal computer 57 (1) through the Ethernet 58 to the VTR 1.

The VTR 1 reproduces the video data (clip) of the designated range based on the file information and the transfer command. Such video data is transferred through the fiber channel 56 and the switch 55 to the workstation 51 (1), audio data and meta-data are transferred through the Ethernet 58 to the workstation 51 (1) and proxy video data with lowered resolution is transferred through the Ethernet 58 to the personal computer 57 (1).

In the workstation 51 (1), after the thus transferred video data and audio data were added thereto as the file, the file and a transfer command (SCSI transfer command) for requesting storage of such file are transferred through the fiber channel 56 and the switch 55 to the storage 52. The storage 52 stores therein the thus transferred file based on the transferred command. Also, the meta-data transferred to the workstation 51 (1) is transferred from the workstation 51 (1) to the meta-data server 54.

The personal computer 57 (1) displays a list of added files (on the file list display portion 41 shown in FIG. 6) and it also displays the transferred proxy video data (proxy video data of the file added this time) (on the image display portion 42 shown in FIG. 6).

In this manner, a load on the CPU of the workstation 51 (1) can be lightened and the video data with the high resolution recorded on the magnetic tape 24 (FIG. 2) can be transferred from the VTR 1 to the workstation 51 (1) at high speed and thereby it can be added to the workstation 51 (1) as the file.

Also, since the registered file is stored in the storage 52, in this SAN, the workstations 51 (1) to 51 (n), which are the servers, become able to share this file.

In the example shown in FIG. 7, the function of the computer 2 shown in FIG. 1 may be shared with the workstation 51 (1) and the personal computer 57 (1).

Alternatively, as another example, all functions of the computer 2 can be given to the workstation 51 (1) (display function of the GUI picture shown in FIG. 4 and the file information and transfer command transmission function based on the operations on the GUI picture also can be given to the workstation 51 (1)).

Also, the audio data and the meta-data are transferred through the Ethernet in the above-mentioned examples. However, the present invention is not limited thereto, and in the example shown in FIG. 1, the audio data and the meta-data may be transferred through the fiber channel 4. Further, when all functions of the computer 2 shown in FIG. 1 are given to the workstation 51 (1) in the example shown in FIG. 7, the audio data and the meta-data may be transferred through the fiber channel 56 and the switch 55.

Also, while the fiber channel is used as the high-speed interface for transferring video data in the above-mentioned examples, the present invention is not limited thereto, and video data may be transferred by using serial transfer system or parallel transfer system high-speed interface (for example, “HIPPI (High-Performance Parallel Interface)”, “InfiniBand”, parallel SCSI, etc.) other than the fiber channel.

Further, while the present invention is applied to the VTR in the above-mentioned examples, the present invention is not limited thereto, and it can be applied to other video data reproducing apparatus (for example, VCR (video cassette recorder)) than the VTR for reproducing video data from a tape-like recording medium. Alternatively, the present invention may be applied to a video data reproducing apparatus having its own original file system, such as a DVD (digital versatile disc) player and video data transferred from such video data reproducing apparatus to the computer may be converted into the file format by the computer and thereby added to the computer.

Furthermore, while the present invention is applied to the nonlinear editing system in the above-mentioned examples, the present invention is not limited thereto and it can be applied to all sorts of systems ranging of from a video data reproducing apparatus for reproducing video data from a recording medium to a system which is required to transmit video data with high resolution to a computer at high speed so that such video data should be added to the computer as a file.

According to the present invention, when the video data is transferred from the video data reproducing apparatus, which reproduces the video data from the recording medium, to the computer and thereby the transferred video data is added to the computer as the file, since the two paths are properly chosen in use in such a manner as to transmit the file information necessary for adding the file and the transfer command through the LAN (that is, the general protocol such as the http protocol) and in such as manner as to transmit the video data of the large data amount through the high-speed network of the serial transfer system or the parallel transfer system, the load imposed on the CPU of the computer can be lightened. Also, the video data with high resolution can be transferred from the video data reproducing apparatus to the computer at high speed and this video data can be added to the computer as the file.

Also, since the added file is transferred through the high-speed network to the recording apparatus which can be randomly accessed and thereby stored in this recording apparatus, in the SAN (storage area network), for example, a plurality of servers can share this file.

Also, the operator can display the proxy video data on the monitor of the computer and hence the operator can decide the range of the video data to be added to the computer as the file before the file information necessary for adding the file is transmitted to the video data reproducing apparatus

Further, the video data with the high resolution can be transferred to the computer at high speed by the SCSI protocol which is the relatively simple protocol.

The video data with the high resolution can be transferred from the tape-like recording medium to the computer at high speed.

It should be understood by those skilled in the art that various modifications, combinations, sub-combinations and alterations may occur depending on design requirements and other factors insofar as they are within the scope of the appended claims or the equivalents thereof.

1. A video data reproducing apparatus for reproducing video data from a recording medium, comprising:
connection means for a local area network;
connection means for a high-speed network of any transfer system of serial transfer and parallel transfer; and
processing means for reproducing video data of a range designated by file information from said recording medium based on the fact that said file information for designating video data of a constant range of video data recorded on said recording medium as a file and a transfer command for requesting transfer of video data of the range designated by said file information are received through said local area network and transferring reproduced video data through said high-speed network.

2. A video data reproducing apparatus according to claim 1, further comprising processing means for reproducing video data from said recording medium based on the fact that a reproducing command of video data is received through said local area network and wherein said processing means decodes reproduced video data to provide proxy video data and transfers said proxy video data through any one of said local area network and said high-speed network.

3. A video data reproducing apparatus according to claim 1, wherein said high-speed network is a fiber channel.

4. A video data reproducing apparatus according to claim 1, wherein said video data reproducing apparatus reproduces video data from a tape-like recording medium.

5. A video data transfer system comprising:
a video data reproducing apparatus including connection means for a local area network and connection means for a high-speed network of any transfer system of serial transfer and parallel transfer and reproducing video data from a recording medium; and
a computer including said connection means for said local area network and said connection means for said high-speed network, wherein said video data reproducing apparatus reproduces video data of a range designated by file information from said recording medium based on the fact that said file information for designating video data of a constant range of video data recorded on said recording medium as a file and a transfer command for requesting transfer of video data of a range designated by said file information are received through said local area network and transfers reproduced video data to said computer through said high-speed network and said computer adds video data received through said high-speed network as a file.

6. A video data transfer system according to claim 5, wherein said computer transmits said file information and said transfer command to said video data reproducing apparatus through said local area network.

7. A video data transfer system according to claim 5, wherein said video data reproducing apparatus reproduces video data from said recording medium based on the fact that a reproducing command of video data is received through said local area network, it decodes reproduced video data to provide proxy video data and it transfers said proxy video data to a transmission source node of said reproducing command through any one of said local area network and said high-speed network.

8. A video data transfer system according to claim 5, wherein said high-speed network is a fiber channel.

9. A video data transfer system according to claim 5, wherein said video data reproducing apparatus reproduces video data from a tape-like recording medium.

10. A video data transfer system comprising:
a video data reproducing apparatus including connection means for a local area network and connection means for a high-speed network of any transfer system of serial transfer and parallel transfer;
a computer including connection means for said local area network and connection means for said high-speed network; and
a recording apparatus connected to said computer through said high-speed network and which can be randomly accessed, wherein said video data reproducing apparatus reproduces video data of a range designated by file information from said recording medium based on the fact that file information for designating video data of a constant range of video data recorded on said recording medium as a file and a transfer command for requesting transfer of video data of a range designated by said file information are received through said local area network and it transfers reproduced video data to said computer through said high-speed network and said computer adds video data received through said high-speed network as a file and it transfers said video data to said recording apparatus through said high-speed network so that said video data is stored in said recording apparatus.

11. A video data transfer system according to claim 10, wherein said computer transmits said file information and said transfer command through said local area network to said video data reproducing apparatus.

12. A video data transfer system according to claim 10, wherein said video data reproducing apparatus reproduces video data from said recording medium based on the fact that a reproducing command of video data is received through said local area network, it decodes reproduced video data to provide proxy video data and it transfers said proxy video data to a transmission source node of said reproducing command through any of said local area network and said high-speed network.

13. A video data transfer system according to claim 10, wherein said high-speed network is a fiber channel.

14. A video data transfer system according to claim 10, wherein said video data reproducing apparatus reproduces video data from a tape-like recording medium.

15. A video data reproducing method for reproducing video data from a recording medium and transferring reproduced video data, comprising the steps of:
a receiving step for receiving file information for designating video data of a constant range of video data recorded on said recording medium and a transfer command for requesting transfer of video data of the range designated by said file information through said local area network;
a reproducing step for reproducing said video data of said range designated by said file information from said recording medium; and
a video data transfer step for transferring said reproduced video data through a high-speed network of any transfer system of serial transfer and parallel transfer.

16. A video data reproducing method according to claim 15, further comprising a receiving step for receiving a reproducing command of video data through said local area network and a proxy video data transfer step for reproducing video data from said recording medium based on said reproducing command, decoding said reproduced data to provide proxy video data and transferring said proxy video data through any of said local area network and said high-speed network.

17. A data transfer method for a video data transfer system comprising a video data reproducing apparatus including connection means for a local area network and connection means for a high-speed network of any transfer system of serial transfer and parallel transfer and which reproduces video data from a recording medium and a computer including said connection means for said local area network and said connection means for said high-speed network, said video data reproducing apparatus including the steps of:
a reception step for receiving file information for designating video data of a constant range of video data recorded on said recording medium and a transfer command for requesting transfer of video data of the range designated by said file information through said local area network; and
a reproducing step for the video data of the range designated by said file information from said recording medium;
a transfer step for transferring said reproduced video data through said high-speed network to said computer; and
said computer including an adding step for adding the video data received through said high-speed network as a file.

18. A data transfer method for a video data transfer system according to claim 17, wherein said computer further includes a transmitting step for transmitting said file information and said transfer command through said local area network to said video data reproducing apparatus.

19. A data transfer method for a video data transfer system according to claim 17, further comprising the steps of:
a receiving step for receiving a reproducing command of video data through said local area network; and
a proxy video data transfer step for reproducing video data from said recording medium based on said reproducing command, decoding the reproduced video data to provide proxy video data and transferring said proxy video data through any one of said local area network and said high-speed network.

20. A data transfer method for a video data transfer system comprising:
a video data reproducing apparatus including connection means for a local area network and connection means for a high-speed network of any transfer system of serial transfer and parallel transfer and reproducing video data from a recording medium;
a computer including connection means for said local area network and connection means for said high-speed network; and
a recording apparatus connected to said computer by said high-speed network and which can be randomly accessed;
said video data reproducing apparatus includes a receiving step for receiving file information for designating video data of a constant range of video data recorded on said recording medium as a file and a transfer command for requesting transfer of video data of the range designated by said file information through said local area network;
a reproducing step for reproducing the video data of the range designated by said file information from said recording medium; and
a transfer step for transferring said reproduced video data through said high-speed network to said computer; and
said computer includes the step of:
an add step for adding video data received through said high-speed network as a file; and
said recording apparatus which can be randomly accessed includes a storage step for storing video data file transferred through said high-speed network.

21. A data transfer method for a video data transfer system according to claim 20, wherein said computer further includes a transmitting step for transmitting said file information and said transfer command through said local area network to said video data reproducing apparatus.

22. A data transfer method for a video data transfer system according to claim 20, further comprising the steps of:
a receiving step for receiving a reproducing command of video data through said local area network; and
a proxy video data transfer step for reproducing video data from said recording medium based on said reproducing command, decoding the reproduced video data to provide proxy video data and transferring said proxy video data through any one of said local area network and said high-speed network.
